(19) United States
(12) Patent Application Publication
(10) Pub. No.: US 2009/0197532 A1
(43) Pub. Date: Aug. 6, 2009

(54) POWER CONSUMPTION NORMALIZATION FOR DEVICES WITHIN A DISTRIBUTED NETWORK

(75) Inventor: George Wyper, Opio (FR)

Correspondence Address: BRAKE HUGHES BELLERMANN LLP;c/o CPA Global, P.O. Box 52050, Minneapolis, MN, 55402, US

(73) Assignee: BROADCOM CORPORATION, Irvine, CA (US)

(21) Appl. No.: 12/023,703

(22) Filed: Jan. 31, 2008

(51) Int. Cl. H04B 7/00; H04M 1/00

(52) U.S. Cl. 455/41.2; 455/569.1

(57) ABSTRACT

An apparatus may include a power monitor that is arranged and configured to monitor a level of power, a link module that is arranged and configured to establish a wireless link having link parameters with a first device, a link parameters module that is arranged and configured to monitor the link parameters, and a transfer control module that is arranged and configured to communicate the link parameters to a second device and transfer control of the wireless link to the second device.

### TECHNICAL FIELD

This description relates to power consumption normalization for one or more devices within a distributed network.

### BACKGROUND

In a distributed network, multiple devices may be linked together in the network. In one example configuration, a first device may transmit an audio signal to a second device and the second device may forward the audio signal to a third device. In this example configuration, the second device may exhibit a higher power consumption than the third device due to increased radio and processing activity. For instance, the second device may receive the audio signal from the first device, play the audio signal and forward the audio signal to the third device. The third device may only receive the audio signal from the second device and play the audio signal without having to forward the audio signal. Thus, there may be uneven power consumption as between the second device and the third device. In a configuration, where the second device and the third device are the same type of device and part of a system along with the first device, the useful power source life of the system may be limited by the second device due to the uneven power consumption as between the second device and the third device.

### SUMMARY

The details of one or more implementations are set forth in the accompanying drawings and the description below. Other features will be apparent from the description and drawings, and from the claims.

### BRIEF DESCRIPTION OF THE DRAWINGS

FIG. 1 is an exemplary block diagram of a device.

FIG. 2 is an exemplary block diagram of a system including an exemplary implementation of the device of FIG. 1.

FIG. 3 is an exemplary block diagram of an exemplary implementation of the system of FIG. 2.

FIG. 4 is an exemplary chart of exemplary power discharge profiles for devices.

FIG. 5 is an exemplary flowchart illustrating example operations of the devices of FIGS. 1 and 2.

### DETAILED DESCRIPTION

In a distributed network, the useful power source life of a system of devices may be extended. In one exemplary implementation, the useful power source life of the system may be extended by switching the modes of the devices in the system. For example, a device may be in an intermediary mode, where the device receives an audio signal from an audio transmitting device over a wireless link having link parameters, plays the audio signal and forwards the audio signal to another device using a different wireless link. The device that receives the forwarded audio signal may be in an end mode, where the device receives and plays the audio signal, but does not forward the audio signal to another device. Because the device in the intermediary mode may consume power faster than the device in the end mode, the two devices may switch modes at some point during the operation of the system in order to extend the useful power source life of the system. Thus, the device in the end mode may switch to the intermediary mode and the device in the intermediary mode may switch to the end mode.

The switching of modes may occur without the audio transmitting device being aware of the switch and without interruption to the playing of the audio signal by either of the devices. The devices may perform the mode switch by the device in the intermediary mode providing the link parameters to the device in the end mode to enable the device in the end mode to switch to the intermediary mode and take over the wireless link with the audio transmitting device using the link parameters.

For example, the audio transmitting device may include a device that is configured to stream an audio signal to a first wireless earpiece and the first wireless earpiece forwards the audio signal to a second wireless earpiece. In this manner, a user may experience a stereo broadcast of the audio signal from the audio transmitting device using the first wireless earpiece and the second wireless earpiece. The first wireless earpiece may be in an intermediary mode and the second wireless earpiece may be in an end mode. Without the earpieces ever switching modes, the first wireless earpiece, which is in the intermediary mode, may consume power faster than the second wireless earpiece, which is in the end mode. However, if the first wireless earpiece switches to the end mode and the second wireless earpiece switches to the intermediary mode at some point during the operation of the system, then the first wireless earpiece will no longer consume power faster than the second wireless earpiece and the power source life of overall system may be extended.

After switching modes, the second wireless earpiece, which is now in the intermediary mode, receives the streamed audio signal from the audio transmitting device, plays the audio signal and forwards the audio signal to the first wireless earpiece. The first wireless earpiece, which is now in the end mode, no longer receives the streamed audio signal from the audio transmitting device, but instead receives the forwarded audio signal from the second wireless earpiece and plays the audio signal.

The switch of modes between the first wireless earpiece and the second wireless earpiece may occur without knowledge of the audio transmitting device and without interruption of the stereo audio signal being played for a user. Thus, only the first wireless earpiece and the second wireless earpiece are aware of the switch of modes.

The switching of modes may operate to normalize the power consumption between the first wireless earpiece and the second wireless earpiece. Instead of always having the same wireless earpiece being used in the intermediary mode, which may consume more power than a wireless earpiece in the end mode, the wireless earpieces switch modes to optimize and even out the power consumption of the wireless earpieces. The switch of modes may occur with the first wireless earpiece transferring link parameters to the second wireless earpiece, such that the second wireless earpiece has the information to take over the active wireless link with the audio transmitting device using the link parameters.

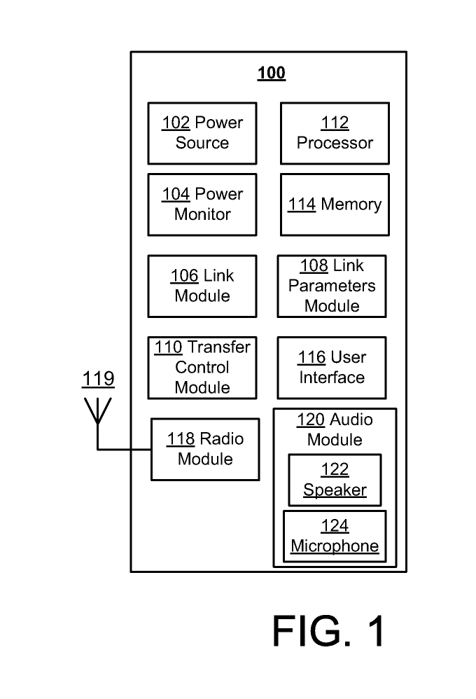

Referring to FIG. 1, a device 100 may include a power source 102, a power monitor 104, a link module 106, a link parameters module 108, a transfer control module 110, a processor 112, a memory 114, a user interface 116, a radio module 118, an antenna 119, and an audio module 120. The device 100 may be arranged and configured to operate in one or more modes including an intermediary mode and an end mode. The device 100 may include, for example, a wireless earpiece, a wireless headset, a wireless speaker, a voice over internet protocol (VoIP) telephone, or any device that is capable of receiving a wireless audio signal, playing the audio signal through a speaker and forwarding the audio signal to another wireless device.

The power source 102 may include one or more disposable and/or rechargeable batteries. For example, in one exemplary implementation, the power source 102 may include one or more rechargeable lithium ion batteries. Other types of power sources may be used other than batteries.

The power monitor 104 may be arranged and configured to monitor a level of power for the power source 102. The power monitor 104 may be configured to provide an indication and/or a trigger when the level of power for the power source 102 reaches a threshold level. For example, the power monitor 104 may provide an indication to a user when the power source reaches a threshold level to indicate to the user that the device 100 has reached the point that may be set for the device 100 to switch from the intermediary mode to the end mode. In another exemplary implementation, the power monitor 104 may not provide any indication to the user, but instead provide a trigger when the power source 102 reaches the point that may be set for the device 100 to switch from the intermediary mode to the end mode.

In one exemplary implementation, the power monitor 104 may monitor the level of power for the power source 102 by monitoring the current consumption of the power source 102. For example, if the power source 102 is a battery, the power monitor 104 may monitor the forward current consumption of the battery. The power monitor 104 may measure the current consumption of the battery and use the current consumption to determine when the power source 102 has reached a threshold level, where that threshold level may serve as a trigger for one or more different type of events.

The link module 106 may be arranged and configured to establish one or more wireless links with one or more devices, as the case may be. For example, the link module 106 may establish a first wireless link with a first device and a second wireless link with a second device. Each of the first wireless link and the second wireless link may have link parameters that may define the characteristics of the links and/or define the characteristics of the information being communicated using the wireless links.

In one exemplary implementation, device 100 may be a Bluetooth®-enabled device and the wireless links established by the link module 106 may include Bluetooth wireless links that use the Bluetooth protocol to establish the links and to communicate information between device 100 and other Bluetooth-enabled devices using the wireless links.

In other exemplary implementations, the link module 106 may use other wireless protocols to establish wireless links with other devices. The link module 106 may use the same wireless protocol to establish the wireless links. Alternatively, the link module 106 may be configured to use different wireless protocols for different, simultaneous wireless links. For instance, the link module may use a first wireless protocol to establish a first wireless link with a first device and may use a second wireless protocol that differs from the first wireless protocol to establish a second wireless link with a second device.

The link parameters module 108 may be arranged and configured to monitor the link parameters for one or more wireless links established by the link module 106. The link parameters module 108 may retrieve the link parameters from the module 106 and/or the link module 106 may provide the link parameters to the link parameters module 108. The link parameters module 108 may include a type of memory to store the monitored link parameters.

The link parameters may include any information necessary for the one device to transfer control of a wireless link to another device without any perceivable interruption to the information being communicated between devices. The link parameters may include information that may be used by one or more components of device 100. For example, the link parameters may include information that may be used by the link module 106, the transfer control module 110, radio module 118, and the audio module 120.

The link parameters may include address information for a device such as, for example, a medium access control (MAC) address, an internet protocol (IP) address, or other types of addresses. The MAC address information may include Bluetooth device address information. The link parameters may include timing information including a timing information associated with a clock in a device and timing offset information. For instance, the timing information may include the clock information for a master device and the timing offset information used by a slave device to apply to the master device timing sequence. The link parameters may include modulation information, which may include packet type information and the type of modulation used in the packets. The link parameters also may include codec information and caller identification information.

The transfer control module 110 may be arranged and configured to communicate the link parameters to another device and to transfer control of a wireless link to the other device. For example, device 100 may establish a first wireless link with a first device using the link module 106. The link parameters module 108 may monitor the wireless link and obtain the link parameters for the wireless link with the first device. In one implementation, device 100 may establish a second wireless link with a second device using the link module 106. The transfer control module 110 may communicate the link parameters associated with the first wireless link to the second device to enable the second device to listen in on the first wireless link. The transfer control module 110 may transfer control of the first wireless link to the second device such that the second device and the first device are communicating using the first wireless link. Device 100 may terminate the first wireless link with the first device.

In one exemplary implementation, the device 100 may be a Bluetooth-enabled wireless headset and the first device may be a Bluetooth-enabled phone. The audio module 120 of device 100 may include a speaker 122 and a microphone 124 to enable a user to use the wireless headset to have bi-directional communications with the phone so that a user can, for example, have a hands-free phone conversation. Thus, the wireless headset and the phone may use the first wireless link for communications.

The power monitor 104 may provide an indication to a user when the power source 102 reaches a low power point. The user may then power up the second device, which may be a second wireless headset. The device 100 and the second wireless headset may establish the second wireless link using the link module 106. The transfer control module 110 may communicate the link parameters for the first wireless link to the second wireless headset.

Once the second wireless headset has received the link parameters for the first wireless link, the second wireless headset may begin listening in on the first wireless link. While listening in, a speaker in the second wireless headset may play the audio signal from the first wireless link, but the microphone in the second wireless headset may not yet be enabled until control of the first wireless link is given to the second wireless headset. The transfer control module 110 may transfer control of the first wireless link to the second wireless headset. The transfer control module 110 may transfer control of the first wireless link to the second wireless headset without interruption of the audio signal to and from the phone and without knowledge of the phone.

Thus, wireless headsets may be hot swapped during an active phone conversation without interruption of the conversation and without the phone having to be aware that the swap has occurred. This enables a user to continue having a hands-free phone conversation using the second wireless headset should the first wireless headset have a low battery. After device 100 has transferred control to the second device, then device 100 may be powered down and the power source 102 may be recharged.

In one exemplary implementation, the transfer control module 110 may prompt a user for user input to affirmatively transfer control of the first wireless link from device 100 to the second wireless headset. For example, the user may push a button on device 100 to confirm the transfer of the first wireless link to the second wireless headset. In another exemplary implementation, the transfer control module 110 may transfer control of the first wireless link to the second wireless headset automatically and without any user input.

The processor 112 may be arranged and configured to control the functioning and overall operation of the device 100, including the other components of the device 100. The processor 112 may include application specific firmware, operating instructions, and/or other software to control the operation of the device 100.

The memory 114 may be arranged and configured to store information to be used by other components of the device 100. For example, the memory 114 may store any information related to the link module 106 and the link parameters module 108. The memory 114 also may store any type of configuration information, including any configurable settings, relating to the device 100.

The user interface 116 may be arranged and configured to accept input from a user and to convey information to a user through a display or otherwise. For example, the user interface 116 may include one or more input buttons and/or switches on a wireless headset or a wireless earpiece.

The radio module 118 may be configured to receive and transmit audio and/or data signals. For example, the radio module 118 may include a receiver and a transmitter to enable the device 100 to receive and transmit information. The radio module 118 may be a part of the physical layer where the actual communications between devices take place. Antenna 119 may be configured to work in conjunction with the radio module 118 to receive and transmit information.

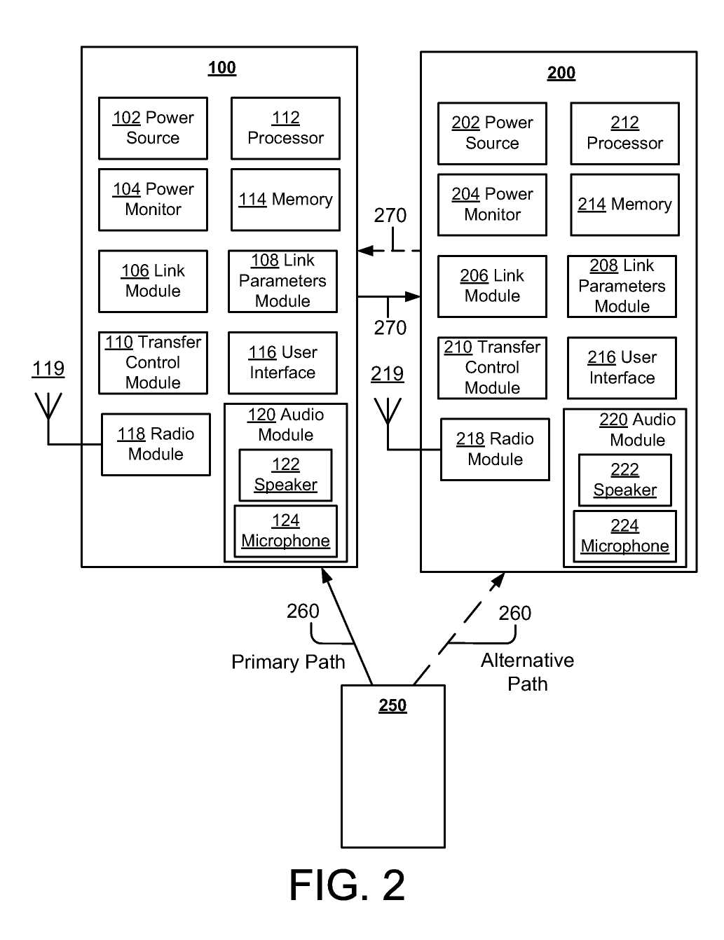

Referring to FIG. 2, device 100 is illustrated along with device 200 and an audio transmitting device 250. FIG. 2 provides an exemplary illustration of the uses and applications of device 100 in a distributed network with device 200 and audio transmitting device 250. The distributed network may include, for example, a Bluetooth pico-net, a scatter-net, or other type of distributed network. Device 200 may include the same and/or similar components as device 100, where those components may be arranged and configured to function as described above with respect to FIG. 1. For example, device 200 may include a power source 202, a power monitor 204, a link module 206, a link parameters module 208, a transfer control module 210, a processor 212, a memory 214, a user interface 216, a radio module 218, an antenna 219, and an audio module 220 having a speaker 222 and a microphone 224, each of which may function the same as or similar to the similarly named and numbered components of device 100, as described above with respect to FIG. 1.

In one exemplary implementation, device 200 may be the same device or same type of device as device 100. For example, device 200 may include a wireless earpiece, a wireless headset, a wireless speaker, a voice over internet protocol (VoIP) telephone, or any device that is capable of receiving a wireless audio signal, playing the audio signal through a speaker and forwarding the audio signal to another wireless device. Device 200 may be arranged and configured to operate in one or more modes including an intermediary mode and an end mode.

In one exemplary implementation, device 200 may be a Bluetooth®-enabled device and the wireless links established by the link module 206 may include Bluetooth wireless links that use the Bluetooth protocol to establish the links and to communicate information between device 200 and other Bluetooth-enabled devices using the wireless links.

The audio transmitting device 250 may include a cellular phone, a smart phone, an MP3 player, an iPod® player, a personal digital assistant (PDA), a mobile handset, a personal computer (PC), other types of devices, and/or in devices that include a combination of these types of devices. The audio transmitting device 250 may be arranged and configured to communicate with other devices using a communication protocol. For example, the audio transmitting device 250 may use the Bluetooth protocol to communicate with other devices such as, for example, device 100 and device 200.

In one exemplary implementation, device 100 and device 200 may be the same device or type of device. For example, device 100 and device 200 may each be a wireless earpiece or a wireless headset. Device 100 and device 200 may be used together such that the separate wireless earpieces working together may function as wireless stereo earphones.

Device 100 may be arranged and configured to operate in an intermediary mode such that device 100 receives an audio signal from audio transmitting device 250, plays the audio signal using speaker 122 and transmits the audio signal to device 200. For instance, the link module 106 may establish a first wireless link 260 having link parameters with the audio transmitting device 250, also labelled as primary path in FIG. 2. The link parameters module 108 may monitor the link parameters associated with the first wireless link 260. The link module 106 also may establish a second wireless link 270 with the device 200 to enable radio module 118 to forward the audio signal to device 200.

Device 200 may be arranged and configured to operate in an end mode such that device 200 receives the audio signal forwarded from device 100 and plays the audio signal using speaker 222. For example, device 200 may receive the audio signal from device 100 using the second wireless link 270. Device 100, which is operating in the intermediary mode, may consume more power and/or consume power faster than device 200, which is operating in the end mode.

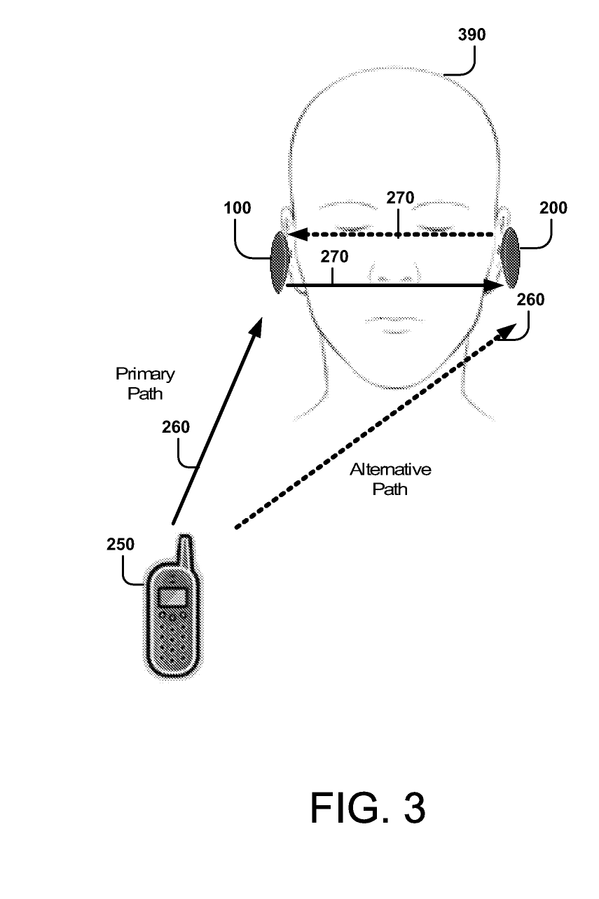

Referring also to FIG. 3, an exemplary implementation of an example configuration of device 100, device 200 and audio transmitting device 250 is illustrated. In this example, device 100 may be a first wireless earpiece, device 200 may be a second wireless earpiece and the audio transmitting device 250 may be a phone. In this example, each of the devices may be Bluetooth-enabled. The audio transmitting device 250 communicates the audio signal to device 100 using the first wireless link 260, also labelled in FIG. 3 as the primary path. Device 100 may be operating in an intermediary mode such that it receives an plays the audio signal and also forwards the audio signal to device 200 using the second wireless link 270. Device 200 may be operating in an end mode such that device 200 receives the audio signal and plays the audio signal, but may not forward the audio signal to another device.

As can be seen in the example of FIG. 3, a user 390 is provided a wireless stereo system using device 100, device 200 and audio transmitting device 250, where the audio signal is being streamed from audio transmitting device 250 to device 100 and from device 100 to device 200. However, as discussed above, device 100 may consume power faster than device 200 since device 100 is operating in the intermediary mode. If device 100 continues to operate in the intermediary mode, then device 100 may run out of power before device 200. Thus, the overall useful power life of the system is reduced, even though device 200 may still have power remaining.

To extend the overall system life and to normalize the power usage as between device 100 and device 200, device 200 may be configured to switch from the end mode to the intermediary mode such that device 200 receives the audio signal from the audio transmitting device 250, plays the audio signal using speaker 222 and forwards the audio signal to device 100. Device 100 may be configured to switch from the intermediary mode to the end mode such that device 100 receives the audio signal from device 200, stops receiving the audio signal from the audio transmitting device 250 and continues to play the audio signal using speaker 122.

The switch of modes may be triggered using the power monitor 104 and/or the power monitor 204. For example, the power monitor 104 may provide a trigger for device 100 to switch modes when the power level of the power source reaches a threshold level. In one exemplary implementation, the threshold level may be at or about when 50% of the power source 102 is remaining. In other implementations, the threshold level may be set at other levels taking into account, for example, the type of the power source 102 and the rate of the power consumption as may be measured by the power monitor 104. When device 100 and device 200 switch modes, the mode switches may occur without any indication to the user 390 or without any perceptible notice by the user 390. The mode switches may occur without the audio transmitting device 250 being aware of the switch or being aware what mode a particular device is in.

In another exemplary implementation, the switch of modes may occur on a periodic basis. For example, the power monitor 104 and/or the power monitor 204 may be arranged and configured to provide a trigger for the devices 100 and 200 to switch modes on a configurable periodic basis.

When the power monitor 104 and/or the power monitor 204 provides the trigger, the link parameters module 108 may provide the link parameters associated with the first wireless link 260 to the transfer control module 110. The transfer control module 110 may communicate the link parameters to device 200 using the second wireless link 270. Once device 200 receives the link parameters from the transfer control module 110, device 200 can listen in on the first wireless link 260. Then, the transfer control module 270 may transfer control of the first wireless link 260 to device 200. Upon the transfer of control of the first wireless link 260 to device 200, also labelled as alternative path in FIG. 2, then device 200 switches modes to the intermediary mode and device 100 switches modes to the end mode. When device 100 is in the end mode, device 100 may consume less power than when it was in the intermediary mode. When device 200 is in the intermediary mode, device 200 may consume more power than when it was in the end mode.

Referring again to FIG. 3, when the transfer control module 110 transfers control of the first wireless link 260 to device 200, then device 200 receives the audio signal from the audio transmitting device 250 using the first wireless link 260, also labelled on FIG. 3 as the dashed line alternative path. Device 200 is able to use the first wireless link 260 because device 100 has communicated the link parameters associated with the first wireless link 260 to device 200. The link parameters include the information to enable device 200 to use the first wireless link 260 to receive the audio signal from the audio transmitting device 250. Device 200 plays the audio signal using speaker 222 and forwards the audio signal to device 100 using the second wireless link 270. The change of the audio signal from the primary path to the alternative path may occur without knowledge of the audio transmitting device 250 and may occur while the first wireless link 260 and/or the second wireless link 270 are active links.

In one exemplary implementation, device 100 and device 200 may exchange information with each other, including device address information. Device 100 and device 200 may exchange the information needed for them to establish the second wireless link 270. For example, device 100 and device 200 may exchange the information during a pairing process in which the two devices 100 and 200 are paired together. In other example implementations, device 100 and device 200 may be pre-programmed with the address information for the other device to enable the establishment of a wireless link between the two devices 100 and 200.

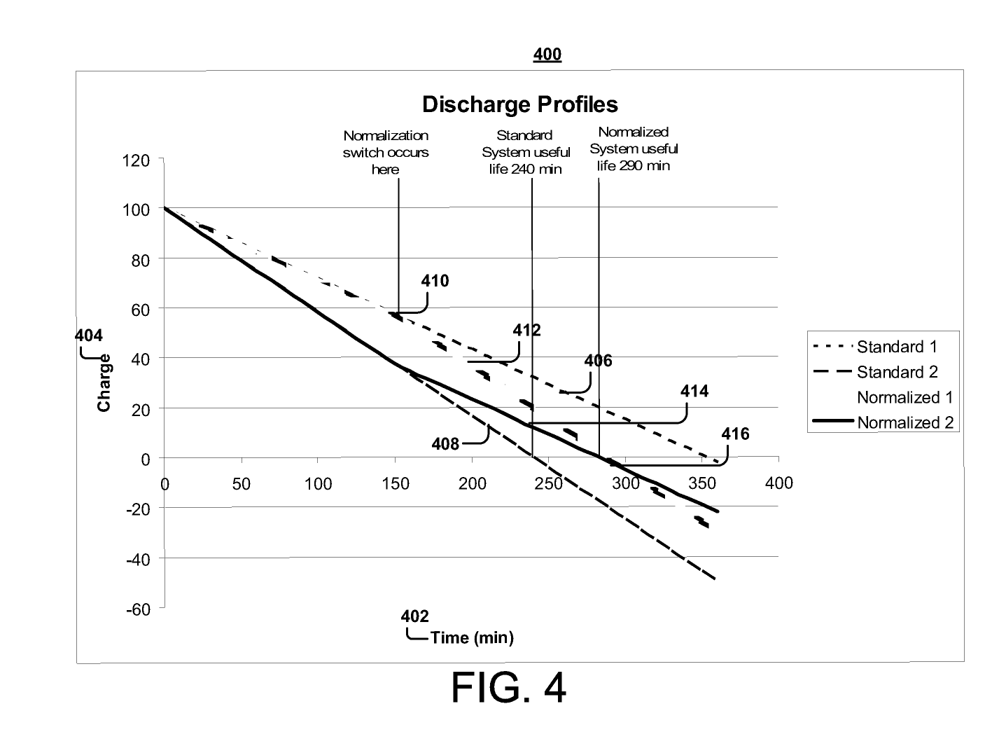

Referring to FIG. 4, an exemplary graph 400 of an example power source discharge profile is illustrated. Graph 400 illustrates an example of the improvement to the overall system power life that may be realized by having device 100 and device 200 switch modes. In graph 400, the x-axis is a time axis in minutes 402 and the y-axis is a charge axis in milliamp hours 404. The example illustrated is based on a power source 102 and power source 202 that include a 100 mAh battery.

The “Standard 1” line 406 may represent device 200 in the end mode. If device 200 were to remain in the end mode without switching to the intermediary mode, then device 200 would have a device useful power life of about 350 minutes. The “Standard 2” line 408 may represent device 100 in the intermediary mode. If device 100 were to remain in the intermediary mode without switching to the end mode, then device 100 would have a device useful power life of about 240 minutes. Thus, the overall system power life would be limited to the device 100 useful power life of about 240 minutes, even though device 200 would still have power remaining.

However, the overall system power life may be extended from about 240 minutes to about 290 minutes by devices 100 and 200 switching modes at point 410. This increase in system power life represents an increase of about 20% in the overall system power life. In this example, the trigger point 410 occurs between 40% and 60% of the remaining battery life for device 200 and between 20% and 40% of the remaining battery life for device 100. The trigger point 410 occurs at slightly above 50% of the remaining battery life for device 200 and occurs at slightly below 40% of the remaining battery life for device 100.

The “Normalized 1” line 412 may represent device 200 when device 200 switches from the end mode to the intermediary mode at the trigger point 410. The “Normalized 2” line 414 may represent device 100 when device 100 switches from the intermediary mode to the end mode at the trigger point 410. Thus, the normalized system use life is about 290 minutes as shown at point 416.

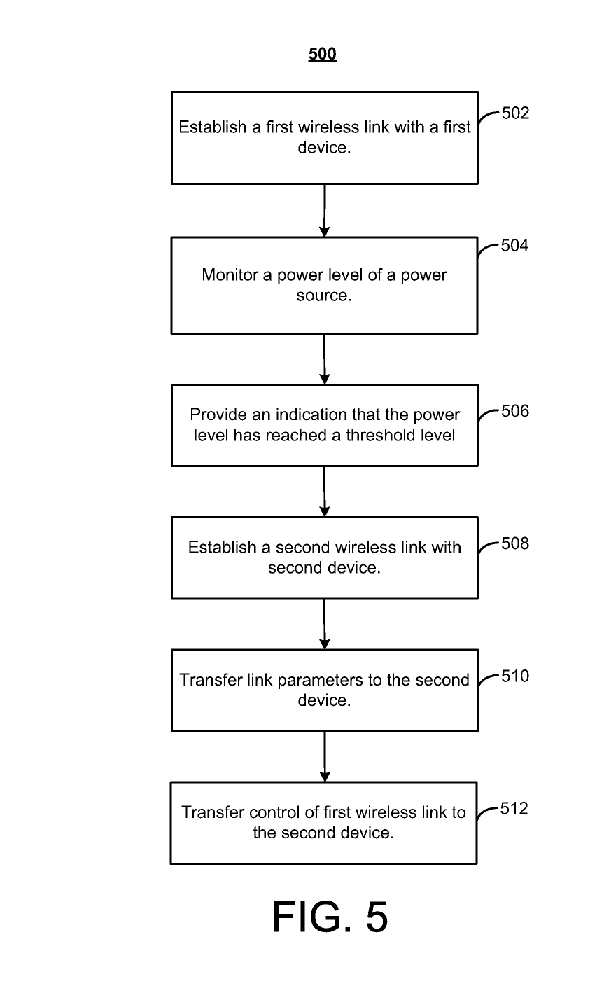

Referring to FIG. 5, an exemplary process 500 illustrates example operations of the devices 100 and 200 and the audio transmitting device 250. Process 500 may illustrate an example operation of device 100 as a wireless headset that is swapped out with another similar device during a hands-free phone conversation. Process 500 includes establishing a first wireless link with a first device (502). For example, the link module 106 may establish a first wireless link with audio transmitting device 250 (502).

Process 500 includes monitoring a power level of a power source (504). For example, the power monitor 104 may monitor the power level of the power source 102 (504). An indication may be provided that the power level has reached a threshold level (506). For example, the power monitor 104 may provide an indication and/or a trigger that the power level of the power source 102 has reached a threshold level (506).

A second wireless link may be established with a second device (508). For example, the link module 106 may establish a second wireless link with device 200 (508). In this manner, device 200 may be powered on by a user upon an indication that device 100 is low on battery power. The link between device 100 and device 200 may be established once device 200 is powered up or otherwise ready.

The link parameters may be transferred to the second device (510). For example, the link parameters module 108 may monitor the link parameters associated with the first wireless link and communicate the link parameters to the transfer control module 110. The transfer control module 110 may transfer the link parameters to device 200 (510). Control of the first wireless link may be transferred to the second device (512). For example, the transfer control module 110 may transfer control of the first wireless link to device 200 (512).

Once control of the first wireless link has been transferred to device 200, then device 200 is in direct communication with audio transmitting device 250. Device 100 may then power down and be recharged by the user.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations.

What is claimed is:

1. An apparatus, comprising:
a power source;
a power monitor that is arranged and configured to monitor a level of power for the power source;
a link module that is arranged and configured to establish a wireless link having link parameters with a first device;
a link parameters module that is arranged and configured to monitor the link parameters; and
a transfer control module that is arranged and configured to:
communicate the link parameters to a second device, and
transfer control of the wireless link to the second device.

2. The apparatus of claim 1 wherein:
the power monitor is arranged and configured to provide an indication when the level of power for the power source reaches a threshold level; and
the transfer control module is arranged and configured to communicate the link parameters to the second device and to transfer control of the wireless link to the second device in response to the indication from the power monitor.

3. The apparatus of claim 1 wherein the link parameters include an address of the first device and timing information related to the wireless link.

4. The apparatus of claim 1 wherein:
the first device includes a Bluetooth-enabled phone;
the wireless link includes a Bluetooth link; and
the second device includes a Bluetooth-enabled wireless earpiece.

5. The apparatus of claim 1 further comprising:
a radio module that is arranged and configured to communicate audio signals with the first device using the wireless link; and
an audio module having a speaker that is arranged and configured to play audio received at the radio module through the wireless link from the first device.

6. The apparatus of claim 1 wherein:
the power source includes a battery; and
the power monitor is arranged and configured to monitor current consumption of the battery.

7. A system, comprising:
a first wireless device having a first speaker that is arranged and configured to operate in an intermediary mode such that the first wireless device receives an audio signal from an audio transmitting device, plays the audio signal using the first speaker, and transmits the audio signal; and
a second wireless device having a second speaker that is arranged and configured to operate in an end mode such that the second wireless device receives the audio signal from the first wireless device and plays the audio signal using the second speaker, wherein:
the second wireless device is further arranged and configured to switch from the end mode to the intermediary mode such that the second wireless device receives the audio signal from the audio transmitting device, stops receiving the audio signal from the first wireless device, plays the audio signal using the second speaker, and transmits the audio signal to the first wireless device, and
the first wireless device is further arranged and configured to switch from the intermediary mode to the end mode such that the first wireless device receives the audio signal from the second wireless device, stops receiving the audio signal from the audio transmitting device, and plays the audio signal using the first speaker.

8. The system of claim 7 wherein the first wireless device is a first wireless earpiece and the second wireless device is a second wireless earpiece.

9. The system of claim 7 wherein the first wireless devices switches from the intermediary mode to the end mode and the second wireless device switches from the end mode to the intermediary mode without awareness of the switches by the audio transmitting device.

10. The system of claim 7 wherein the first wireless device includes:
a battery; and
a power monitor that is configured to trigger the first wireless device to switch from the intermediary mode to the end mode when the battery reaches a threshold level.

11. The system of claim 7 wherein:
the first device is a first Bluetooth-enabled wireless earpiece;
the second device is a second Bluetooth-enabled wireless earpiece; and
the audio transmitting device is a Bluetooth-enabled phone.

12. The system of claim 7 wherein the first wireless device is further arranged and configured to transmit link parameters to the second wireless device to enable the second wireless device to switch from the end mode to the intermediary mode.

13. The system of claim 12 wherein the link parameters include a device address of the audio transmitting device.

14. The system of claim 7 wherein the first wireless device is further arranged and configured to transmit link parameters to the second wireless device to enable the second wireless device to switch from the end mode to the intermediary mode, the link parameters including a device address of the audio transmitting device, timing information, modulation information and codec information.

15. The system of claim 7 wherein the first wireless device consumes less power in the end mode than in the intermediary mode.

16. A system, comprising:
a first device that is arranged and configured to:
receive an audio signal from an audio transmitting device using a first wireless link, the first wireless link having one or more link parameters, and
transmit the audio signal using a second wireless link; and
a second device that is arranged and configured to:
receive the audio signal from the first device using the second wireless link, wherein:
the first device is further arranged and configured to communicate the link parameters to the second device, and
the second device is further arranged and configured to:
receive the link parameters from the first device,
receive the audio signal from the audio transmitting device using the first wireless link, and
transmit the audio signal to the first device using the second wireless link such that the first device stops receiving the audio signal from the audio transmitting device using the first wireless link, stops transmitting the audio signal using the second wireless link, and receives the audio signal from the second device using the second wireless link.

17. The system of claim 16 wherein:
the first device is a first wireless earpiece, and
the second device is a second wireless earpiece.

18. The system of claim 16 wherein the first device includes:
a battery; and
a power monitor that is arranged and configured to monitor a charge of the battery and to provide a trigger for the first device to communicate the information for the link parameters to the second device.

19. The system of claim 16 wherein:
the first device is a first Bluetooth-enabled wireless earpiece;
the second device is a second Bluetooth-enabled wireless earpiece;
the audio transmitting device is a Bluetooth-enabled phone; and
the link parameters include a Bluetooth device address, wherein the first Bluetooth-enabled wireless earpiece is configured to transmit the Bluetooth device address to the second Bluetooth-enabled wireless earpiece and the second Bluetooth-enabled wireless earpiece is configured to receive the Bluetooth device address without the Bluetooth-enabled phone being aware that the Bluetooth device address has been transmitted and received between the first Bluetooth-enabled wireless earpiece and the second Bluetooth-enabled wireless earpiece.

20. The system of claim 16 wherein the link parameters includes an address of the audio transmitting device, timing information, modulation information and codec information.
